(19) United States
(12) Patent Application Publication
(10) Pub. No.: US 2014/0008415 A1
(43) Pub. Date: Jan. 9, 2014

(54) WELDING SYSTEM AND METHOD FOR AUTOMATIC WELDING

(71) Applicants: Hongyuan Shen, Shanghai (CN); Peng Li, Shanghai (CN); Tingting Yang, Shanghai (CN); Yuanbiao Wu, Shanghai (CN); Zhixue Peng, Shanghai (CN); Cheng Sun, Hangzhou (CN); Attila Szabo, Encinitas, CA (US); Meilong Li, Hangzhou (CN)

(72) Inventors: Hongyuan Shen, Shanghai (CN); Peng Li, Shanghai (CN); Tingting Yang, Shanghai (CN); Yuanbiao Wu, Shanghai (CN); Zhixue Peng, Shanghai (CN); Cheng Sun, Hangzhou (CN); Attila Szabo, Encinitas, CA (US); Meilong Li, Hangzhou (CN)

(73) Assignee: General Electric Company

(21) Appl. No.: 13/562,787

(22) Filed: Jul. 31, 2012

(30) Foreign Application Priority Data
Jul. 3, 2012 (CN) 201210229120.X

(51) Int. Cl. B23K 3/00

(52) U.S. Cl. 228/10

(57) ABSTRACT

A welding system for automatically welding a welding seam includes a welding arm, a sensor and a controller. The controller includes a welding seam contour detection component, a welding seam contour calculation component, a welding trajectory point calculation component, and a welding parameter setting component. The welding seam contour detection component is used for detecting an initial welding seam contour and detecting remaining welding seam contours after welding each layer of the welding seam. The welding seam contour calculation component is used for calculating the detected welding seam contours. The welding trajectory point calculation component is used for calculating welding trajectory points based on the calculated welding seam contours. The welding parameter setting component is used for setting welding parameters based on the calculated welding seam contours and the calculated welding trajectory points.

### BACKGROUND

Embodiments of the invention relate generally to an automatic welding system and method using a welding torch for automatic welding a first metal part to a second metal part.

Nowadays, automatic welding technology is widely used in factories, such as automobile factories, for welding two metal parts of products like cars for example.

For example, FIG. 1 shows a conventional welding system 100, together with a product 110 to be welded. As an example, the welding system 100 may include an operation part 120 and a control part 130. The control part 130 is used to control the operation part 120 to perform welding operations for the product 110 according to control commands from the control part 130.

The operation part 120 may include a welding arm 122, a sensor 124, and a welding torch 126. The sensor 124 and the welding torch 126 are generally mounted on the tip of the welding arm 122. The welding arm 122 may include several axes, such as six axes, which can adjust the position and gesture of the sensor 124 and the welding torch 126 flexibly. The product 110 at least includes a first metal part 112 and a second metal part 114 to be welded together. The welded area between the first metal part 112 and the second metal part 112 is referred to as a welding seam 116. The welding torch 126 is used to deposit weld beads 118 into the welding seam 116, pass by pass and layer by layer, in order to weld the first metal part 112 and the second metal part 114 together. The sensor 124 is used to teach predetermined welding trajectory points of the welding seam 116.

Before performing the welding operations, operators need to manually teach every predetermined welding trajectory point, pass by pass and layer by layer, in the welding seam 116. Hereinafter, the welding trajectory point stands for welding positions and welding gestures for depositing each weld bead 118 into the welding seam 116. For example, FIG. 2 shows a schematic welding trajectory point structure of the welding seam 116. As an example, the welding seam 116 may include five layers 1161-1165 for the welding trajectory points 119 which is determined according to the welding seam contour (shape) of the welding seam 116 based on the welding technology. Before being welded, the welding seam contour (herein referred to as the initial welding seam contour) is the biggest welding seam contour due to no weld beads being deposited therein. After one or more welding layers are welded, the welding seam contour (herein referred to as the remaining welding contour) is gradually reduced due to weld beads deposited into the welding seam 116. The first layer 1161 may include a pass p1 of welding trajectory points 119, the second layer 1162 may include two passes p2 and p3 of welding trajectory points 119, the third layer 1163 may include three passes p4-p6 of welding trajectory points 119, the fourth layer 1164 may include four passes p7-p10 of welding trajectory points 119, and the fifth layer 1165 may include five passes p11-p15 of welding trajectory points 118.

Each pass may include several welding trajectory points 119 along the lengthways path of the welding seam 116 based on the length of the welding seam 116. For example, FIG. 3 shows a top view of the fourth layer 1164 of the welding seam 116 of FIG. 2. In this example, the length of the welding seam 116 may be equal to L. As such, the number of the welding trajectory points 119 in each pass will be determined by the length L and the size of the weld bead welded in each welding trajectory point 119.

Referring FIG. 2 again, in the welding seam 116, the first layer 1161 may be called a root welding layer corresponding to a root welding operation, the last layer 1165 may be called a surface welding layer corresponding to a surface welding operation, and the other layers 1162-1164 between the root welding layer and the surface welding layer may be called filling welding layers corresponding to filling welding operations. The welding parameters of the root welding, the filling welding, and the surface welding may be different according to the welding technology requirements. The welding parameters may include welding current, welding speed, oscillation amplitude, wire feed speed and so on. During the manual teaching process, the operators need to teach every predetermined welding trajectory point 119 by operating the control part 130 to drive the sensor 124 to teach every predetermined welding trajectory point 118 pass by pass and layer by layer. The taught points (namely the predetermined welding trajectory points 119) are recorded in the control part 130, and the operator also sets welding parameters in the control part 130 for each taught point 119.

After the teaching process, the operator activates the welding process, whereby the welding system 100 will weld the welding seam 116 of the product 110 according to the taught points recorded in the control part 130 and the set corresponding welding parameters. Thus, the control part 130 drives the welding torch 126 to deposit the weld beads 118 into the welding seam 116 from the first layer to the last layer, pass by pass and layer by layer, according to the manually taught results and corresponding manually set welding parameters.

Even though the above typical welding system 100 can automatically perform a portion of the welding operations on the product 110, the operators still need to spend much time to manually teach every welding trajectory point and set corresponding welding parameters respectively, which is not efficient. Furthermore, because every welding trajectory point needs to be taught manually, if the number of the taught points is huge, some taught points may not be appropriate for welding. For example, when the welding seam is complex, such as when the welding seam is a super-thick welding seam which needs for example thousands of taught points, the typical welding system 100 may not be appropriate for welding such a complex welding seam.

For these and other reasons, there is a need for embodiments of the invention.

### BRIEF DESCRIPTION

In accordance with an embodiment disclosed herein, welding system for welding a welding seam is provided. The welding system includes a welding arm, a sensor and a controller. The sensor is coupled to the welding arm to sense contours of the welding seam. The controller is coupled to the sensor and the welding arm to control the welding process based on the sensed contours. The controller includes a welding seam contour detection component, a welding seam contour calculation component, a welding trajectory point calculation component, and a welding parameter setting component. The welding seam contour detection component is used for detecting an initial welding seam contour and detecting remaining welding seam contours after welding each layer of the welding seam. The welding seam contour calculation component is used for calculating the detected welding seam contours. The welding trajectory point calculation component is used for calculating welding trajectory points based on the calculated welding seam contours. The welding parameter setting component is used for setting welding parameters based on the calculated welding seam contours and the calculated welding trajectory points.

In accordance with another embodiment disclosed herein, a welding method for welding a welding seam is provided. The welding method includes:

detecting and calculating an initial welding seam contour of the welding seam;

calculating welding trajectory points of a root welding based on the calculated initial welding seam contour;

setting welding parameters of the root welding based on the calculated welding trajectory points and the calculated initial welding seam contour;

performing one layer welding based on the set welding parameters;

detecting and calculating a remaining welding seam contour of the welding seam; and

determining whether the calculated remaining welding seam contour is for a surface welding; wherein

when the calculated remaining welding seam contour is not for the surface welding,
calculating welding trajectory points of filling welding based on the calculated remaining welding seam contour, setting welding parameters of filling welding based on the calculated welding trajectory points and the calculated remaining welding seam contour, and performing one layer welding based on the set welding parameters, and

when the calculated remaining welding seam contour is for the surface welding,
calculating welding trajectory points of surface welding based on the calculated remaining welding seam contour, setting welding parameters of surface welding based on the calculated welding trajectory points and the calculated remaining welding seam contour, and performing surface welding based on the set welding parameters.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic view of a conventional automatic welding system, together with a product to be welded.

FIG. 2 is a schematic view of a welding trajectory point structure of a welding seam of the product of FIG. 1.

FIG. 3 is a top view of a fourth layer of the welding seam of FIG. 2.

FIG. 4 is a schematic view of an automatic welding system, together with a product to be welded according to one embodiment.

FIG. 5 is a schematic view of a welding process according to one embodiment.

FIG. 6 is a schematic top view of three different layers of a welding seam.

FIG. 7 is a flowchart of a welding method corresponding to the welding process of FIG. 5 according to one embodiment.

FIG. 8 is a block diagram of a controller corresponding to the welding method of FIG. 7 according to one embodiment.

FIG. 9 is a schematic view of a detailed initial welding seam contour detecting and calculating process performed by the welding method of FIG. 7 according to one embodiment.

FIGS. 10-13 are four schematic views of four different shapes of welding beams.

FIG. 14 is a flowchart of a method corresponding to the detailed process of FIG. 9 according to one embodiment.

FIG. 15 is a partial block diagram of a welding seam contour detection component of the controller of FIG. 8 according to one embodiment.

FIG. 16 is a schematic view of a detailed remaining welding seam contour detecting and calculating process performed by the welding method of FIG. 7 according to one embodiment.

FIG. 17 is a flowchart of a method corresponding to the detailed process of FIG. 16 according to one embodiment.

FIG. 18 is another partial block diagram of a welding seam contour detection component of the controller of FIG. 8 according to one embodiment.

FIG. 19 is a schematic view of a detailed welding trajectory point calculating process performed by the welding method of FIG. 7 according to one embodiment.

FIG. 20 is a flowchart of a method corresponding to the detailed process of FIG. 19 according to one embodiment.

FIG. 21 is a block diagram of a welding trajectory point calculation component of the controller of FIG. 8 according to one embodiment.

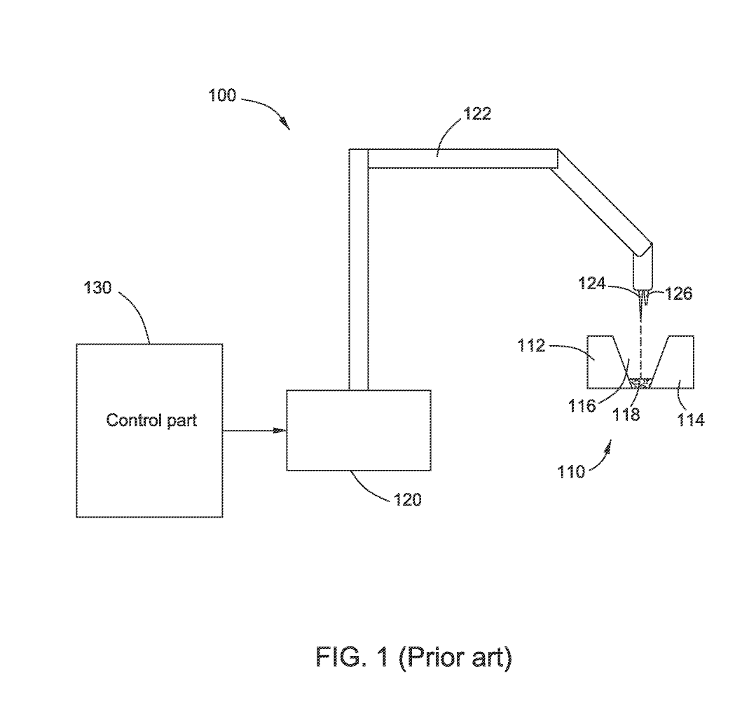

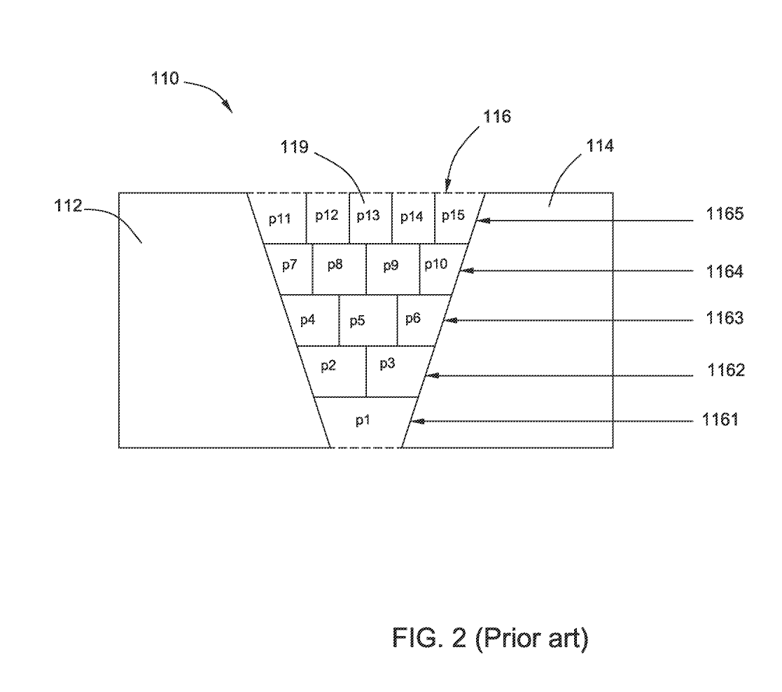

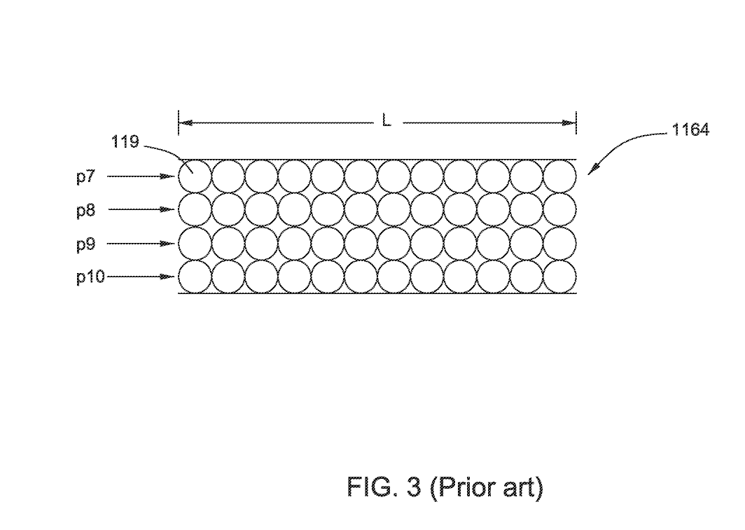

### DETAILED DESCRIPTION

Embodiments of the invention relate to a welding system and a welding method for automatically welding a welding seam. The welding system includes a welding arm, a sensor and a controller. The sensor is coupled to the welding arm to sense contours of the welding seam. The controller is coupled to the sensor and the welding arm to control the welding process based on the sensed contours. The controller includes a welding seam contour detection component, a welding seam contour calculation component, a welding trajectory point calculation component, and a welding parameter setting component. The welding seam contour detection component is used for detecting an initial welding seam contour and detecting remaining welding seam contours after welding each layer of the welding seam. The welding seam contour calculation component is used for calculating the detected welding seam contours. The welding trajectory point calculation component is used for calculating welding trajectory points based on the calculated welding seam contours. The welding parameter setting component is used for setting welding parameters based on the calculated welding seam contours and the calculated welding trajectory points.

Unless defined otherwise, technical and scientific terms used herein have the same meaning as is commonly understood by one of ordinary skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced items, and terms such as “front”, “back”, “bottom”, and/or “top”, unless otherwise noted, are merely used for convenience of description, and are not limited to any one position or spatial orientation. Moreover, the terms “coupled” and “connected” are not intended to distinguish between a direct or indirect coupling/connection between two components. Rather, such components may be directly or indirectly coupled/connected unless otherwise indicated.

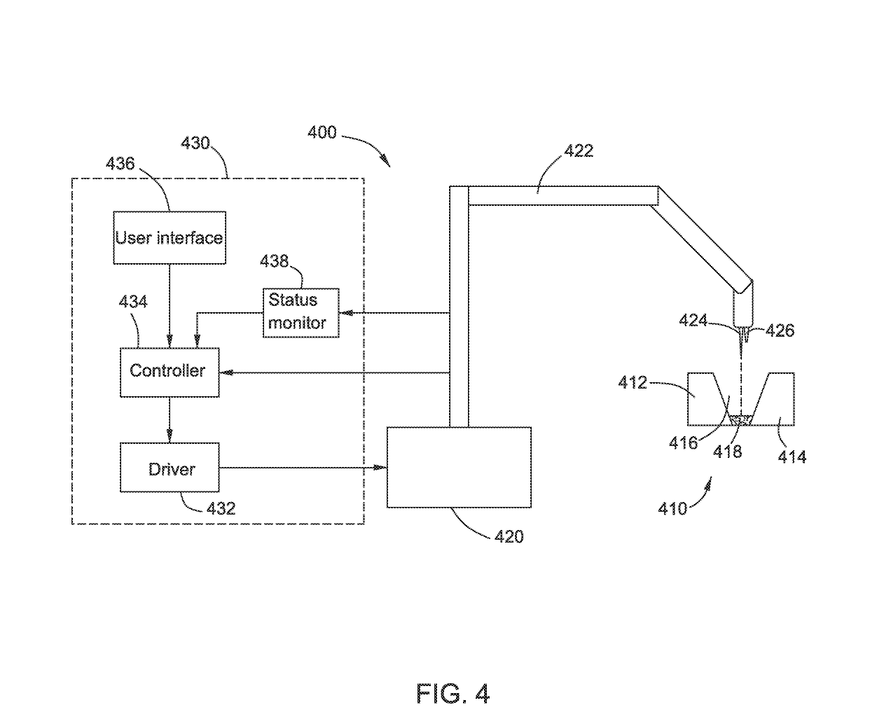

Referring to FIG. 4, a schematic view of an automatic welding system 400, together with a product 410 to be welded according to one embodiment is shown. As an example, the automatic welding system 400 mainly includes an operation part 420 and a control part 430. The control part 430 is used to control the operation part 420 to perform automatic welding operations for the product 410 according to control commands from the control part 430.

In a non-limiting embodiment, the operation part 420 includes a welding arm 422, a sensor 424, and a welding torch 426. The sensor 424 and the welding torch 426 are mounted on the tip of the welding arm 422. The welding arm 422 may include several axes, such as six axes, which can adjust position and gesture of the sensor 424 and the welding torch 426 flexibly. In this embodiment, the welding arm 422 is merely used as an illustrative example for explaining the utility thereof. The type of the welding arm 422 can be adjusted if desired without departing from the spirit and scope of the invention.

The product 410 at least includes a first metal part 412 and a second metal part 414 to be welded together by the automatic welding system 400. The welding torch 426 is used to deposit weld beads 418 into the welding seam 416, pass by pass and layer by layer, in order to automatically weld the first metal part 412 and the second metal part 414 together. The sensor 424 is used to sense the welding seam contour of the initial welding seam 416 and the subsequent remaining welding seams between the first metal part 412 and the second metal part 414. Hereinafter, the initial welding seam contour stands for the shape of the initial welding space of the welding seam before being welded, namely without any weld beads therein; And the remaining welding seam contour stands for the shape of the welding space of the welding seam after being welded one or more layers, namely with at least one layer of weld beads therein. In other words, the initial welding seam contour is the biggest welding seam contour with the remaining welding seam contours being reduced gradually after welding layer by layer. The initial welding seam contour and the remaining welding seam contours together are called whole welding seam contours. The sensor 424 may include a touch sensor or an optical sensor for example. The sensor 424 senses sufficient contour points on the welding seams and sends the sensed signals back to the controller 434 to calculate the initial welding seam contour and the subsequent remaining welding seam contours respectively. Exemplary embodiments will be described in further detail to follow.

In a non-limiting embodiment, the control part 430 may include a driver 432, a controller 434, a user interface 436, and a status monitor 438. The driver 432, such as a motor, is used to directly drive the operation part 420 to perform the welding operation. The controller 434 is used to receive sensing signals from the sensor 424 to calculate welding seam contours, and send corresponding control commands to the driver 432 to drive the operation part 420 according to the calculated welding seams. The user interface 436 may be used to receive manual commands from operators to control the controller 434 to drive the welding arm 422 according to the manual commands. The status monitor 438 is used to monitor the working status of the operation part 420 in real time and send feedback signals to the controller 434. The controller 434 receives the feedback signals from the status monitor 438 and adjusts control commands to the driver 432 accordingly, to make sure the operation part 420 works normally. In other embodiments, two or more of these components of the control part 430 may be integrated together into a common component. For example, the controller 434 may be embedded in the user interface 436. Similarly, one or more components may be further divided into additional components.

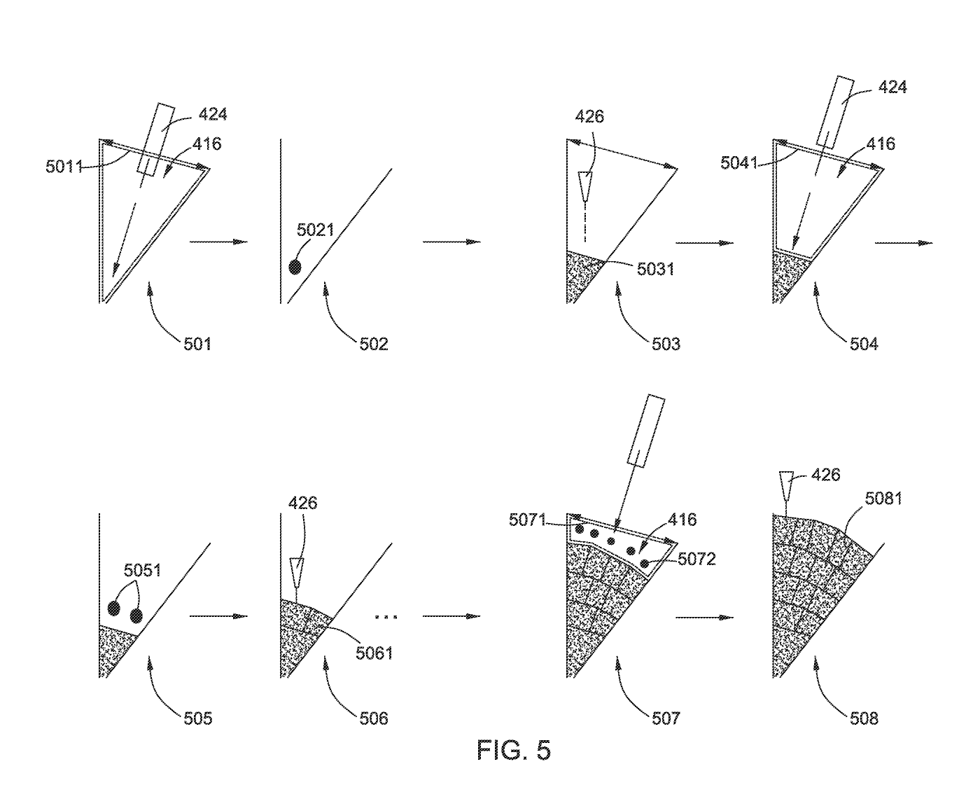

Referring to FIG. 5, a schematic view of a welding process according to one embodiment is shown. In this welding process, the controller 434 automatically calculates the welding trajectory points for the welding seam 416.

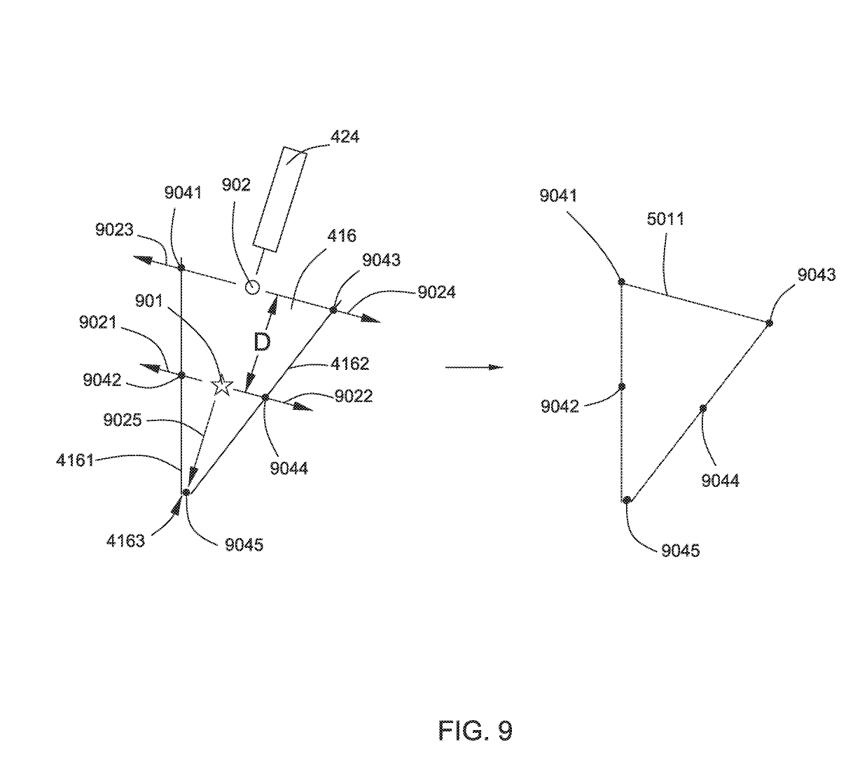

In schematic 501, the controller 434 controls the sensor 424 to sense an initial welding seam contour 5011 of the welding seam 416, and then the initial welding seam contour 5011 is calculated according to geometrical algorithms such as those described with respect to FIG. 9.

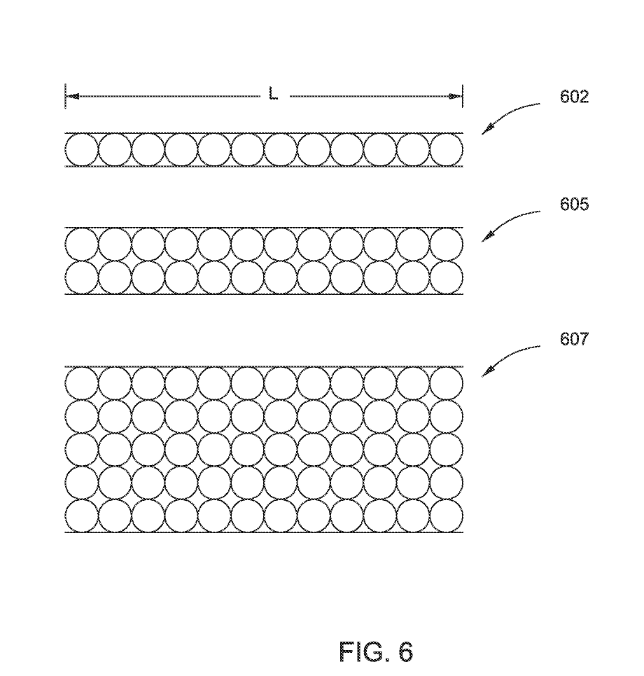

In schematic 502, based on the calculated initial welding seam contour 5011, the welding trajectory points 5021 of a first layer (root welding layer) are calculated. In FIG. 5, the number of the pass of the first layer is one, and the number of the welding trajectory points 5021 of the pass is determined by the length L of the welding seam 416 (see schematic 602 of FIG. 6 as an example). Hereinafter, each one of the calculated welding trajectory points includes information including the welding position of each welding trajectory point and the welding gesture of each welding trajectory point. Meanwhile, based on the calculated initial welding seam contour 5011 and the calculated welding trajectory point 5021, the welding parameters of each welding trajectory point 5021 are calculated accordingly. For example, the welding parameters may include welding current, welding speed, oscillation amplitude, wire feed speed and so on. These welding parameters may be stored in and recalled from a database for use by the controller 434 based on previous experiential welding processes. For example, for one kind of welding torch and the correspondingly used weld bead material, the appropriate welding parameters of a welding trajectory point can be determined and then input into a database. Based on the welding parameters database, the controller 434 can automatically set appropriate welding parameters of each of the calculated welding trajectory points 5021, for subsequent welding operations.

In schematic 503, based on the set parameters of the calculated welding trajectory points 5021, the controller 434 will drive the welding torch 426 to perform the welding operation on the root welding layer, and then a layer of weld beads 5031 are deposited accordingly and the root welding process is finished.

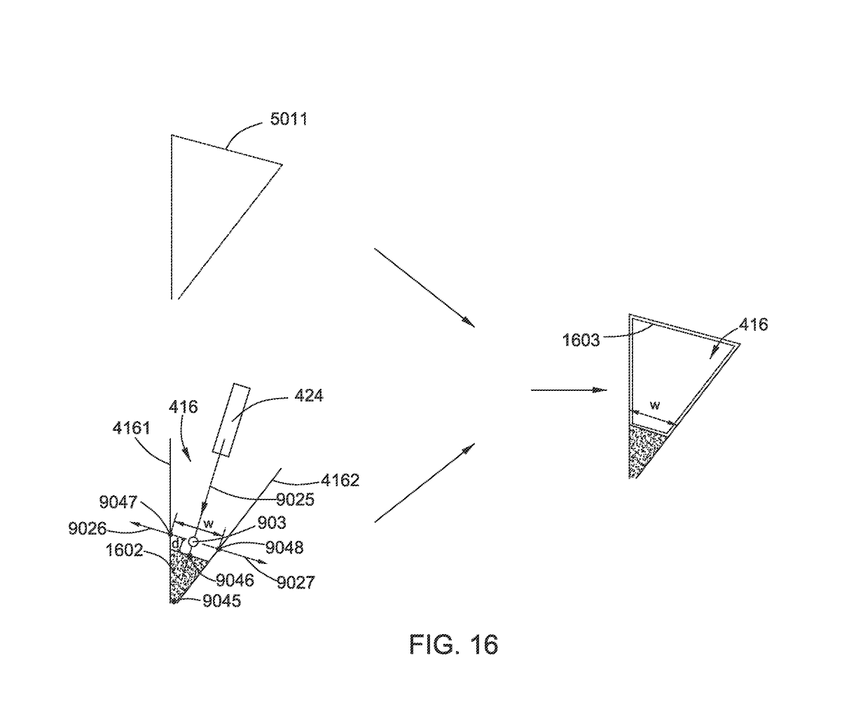

In schematic 504, after one layer is welded, the controller 434 controls the sensor 424 to sense a remaining welding seam contour 5041, and then the remaining welding seam contour 5041 is calculated according to geometrical algorithms such as those described with respect to FIG. 16.

In schematic 505, based on the calculated remaining welding seam contour 5041, the welding trajectory points 5051 of a second layer (e.g., filling welding layer) are calculated. In the illustrated embodiment of FIG. 5, the number of the passes of the second layer is two, and the number of the welding trajectory points 5051 of each pass is determined by the length L of the welding seam 416 (see schematic 605 of FIG. 6 as an example). Meanwhile, based on the calculated remaining welding seam contour 5041 and the calculated welding trajectory points 5051, the welding parameters of each of the welding trajectory points 5051 are calculated according to the welding parameters database mentioned above.

In schematic 506, based on the set parameters of the calculated welding trajectory points 5051, the controller 434 will drive the welding torch 426 to perform the welding operation on the filling welding layer, pass by pass, and then a layer of weld beads 5061 are deposited to finish this filling welding process. Similarly, the subsequent filling welding processes will be performed by the controller 434 similar to that of the second layer welding process, and thus will not be described. During the filling welding processes, every calculated remaining welding seam contour will be determined whether the remaining welding seam contour is to be used for the surface welding process. If the remaining welding seam contour is to be used for the surface welding process, all filling welding processes are finished. More specifically, if the size of the calculated remaining welding seam contour is such that only one layer of weld beads can be deposited, then the calculated remaining welding seam contour is for the surface welding. Contrarily, if the size of the calculated remaining welding seam contour is such that at least two layers of weld beads can be deposited, then the calculated remaining welding seam contour is for the filling welding.

In schematic 507, after all filling welding processes are finished, the controller 434 controls the sensor 424 to sense the last remaining welding seam contour 5071, and then the remaining welding seam contour 5071 is calculated based on geometrical algorithms such as those described with respect to FIG. 16. Based on the calculated remaining welding seam contour 5071, the welding trajectory points 5072 of the last layer (surface welding layer) are calculated. In FIG. 5, the number of the passes of the last layer is five, and the number of the welding trajectory points 5072 of each pass is determined by the length of the welding seam 416 (see schematic 607 of FIG. 6 as an example). Meanwhile, based on the calculated remaining welding seam contour 5071 and the calculated welding trajectory points 5072, the welding parameters of each of the welding trajectory points 5072 are calculated according to the welding parameters database mentioned above.

In schematic 508, based on the set parameters of the calculated welding trajectory points 5072, the controller 434 will drive the welding torch 426 to perform the welding operation on the surface welding layer, pass by pass, and then a layer of weld beads 5081 are deposited accordingly and the surface welding process is finished, and also the whole welding process is finished.

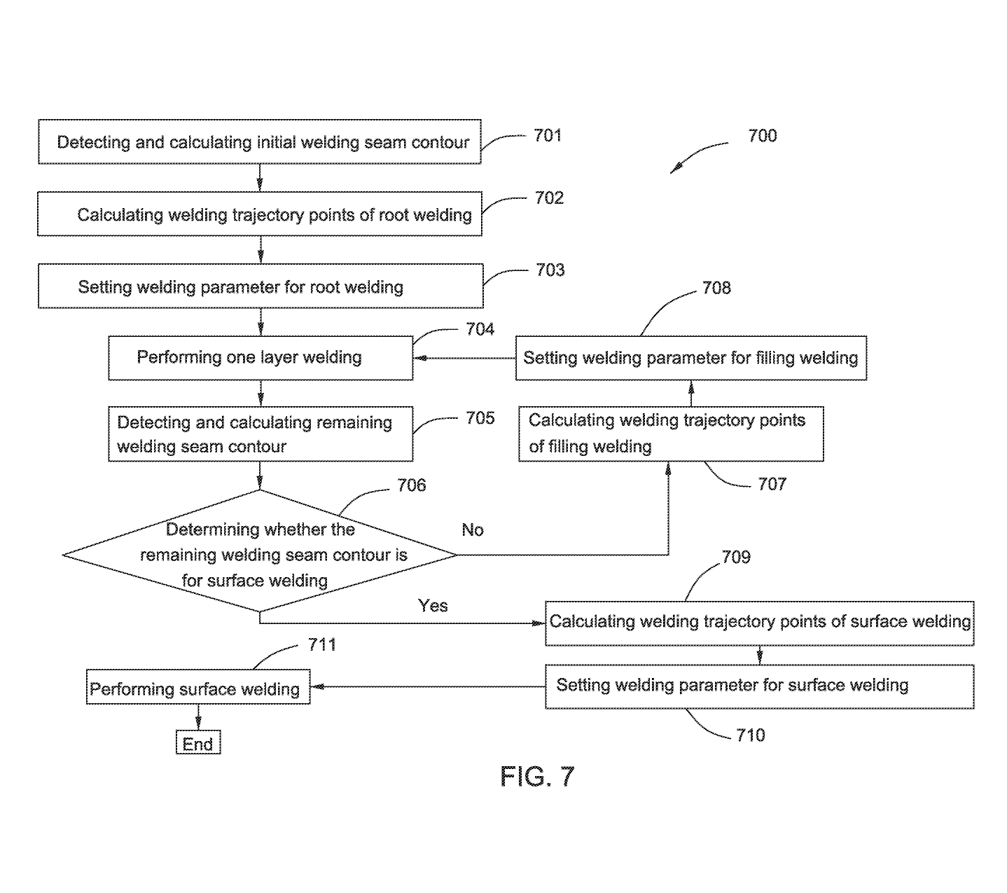

Referring to FIG. 7, a flowchart of a welding method 700 corresponding to the welding process of FIG. 5 according to one embodiment is shown. In one embodiment, the controller 434 uses this welding method 700 to control the operation part 420 to perform welding process shown in FIG. 5. In step 701, an initial welding seam contour 5011 of the welding seam 416 is detected and calculated corresponding to the schematic 501 of FIG. 5. In step 702, the welding trajectory points 5021 for root welding are calculated based on the calculated initial welding seam contour 5011 corresponding to the schematic 502 of FIG. 5. In step 703, the welding parameters of each welding trajectory point 5021 are calculated based on the calculated initial welding seam contour 5011 and the calculated welding trajectory points 5021. In step 704, a layer of welding is performed based on the calculated welding parameters corresponding to the schematic 503 or 506 of FIG. 5. In step 705, a remaining welding seam contour (for example 5041, 5071) of the welding seam 416 is detected and calculated corresponding to the schematic 504, 507 of FIG. 5. In step 706, a determination is made as to whether the calculated remaining welding seam contour (for example 5041, 5071) is for surface welding. If the remaining welding seam contour is not for surface welding (for example 5041), the process goes to step 706. If the remaining welding seam contour is for surface welding (for example 5071), the process goes to step 709. In step 707, the welding trajectory points (for example 5051) for filling welding are calculated based on the calculated remaining welding seam contour (for example 5041) corresponding to the schematic 505 of FIG. 5. In step 708, the welding parameters of each welding trajectory point (for example 5051) are calculated based on the calculated remaining welding seam contour (for example 5041) and the calculated welding trajectory points (for example 5051). The process then goes back to the step 704 to perform another layer of welding. Once a determination is made that the remaining welding seam contour is for the surface welding, in step 709, the welding trajectory points 5072 for surface welding are calculated based on the calculated remaining welding seam contour 5071 corresponding to the schematic 507 of FIG. 5. In step 710, the welding parameters of each welding trajectory point 5072 are calculated based on the calculated remaining welding seam contour 5071 and the calculated welding trajectory points 5072. In step 711, the last layer of welding is performed based on the calculated welding parameters corresponding to the schematic 508 of FIG. 5.

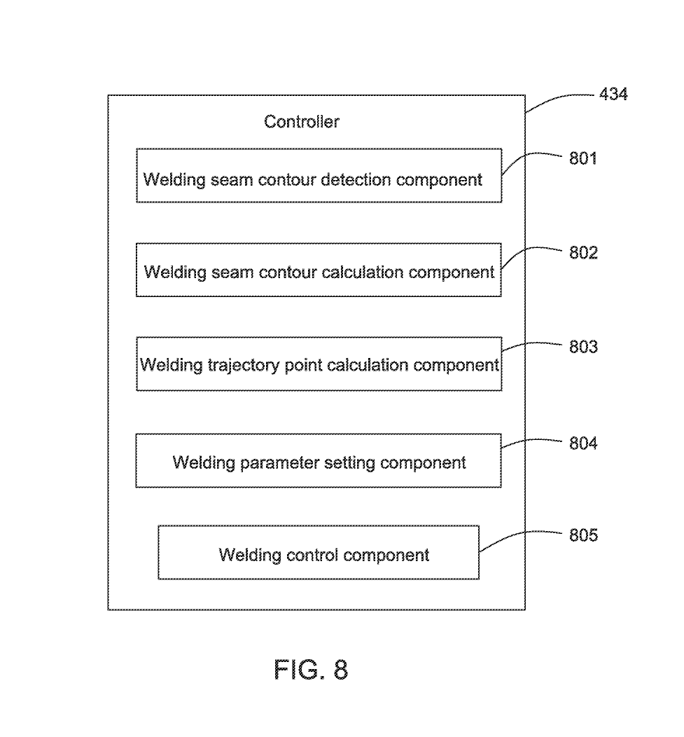

Referring to FIG. 8, a block diagram of the controller 434 corresponding to the welding method 700 of FIG. 7 according to one embodiment is shown. The controller 434 includes a welding seam contour detection component 801, a welding seam contour calculation component 802, a welding trajectory point calculation component 803, a welding parameter setting component 804, and a welding control component 805. These components of the controller 434 are used to implement the welding process of the welding method 700 of FIG. 7. These components of the controller 434 may be programmed with software instructions, or implemented by special-purpose hardware, or implemented by a combination of hardware and software. In other embodiments, one or more of these components of the controller 434 may be integrated together in a common apparatus or the functionality can be further divided into additional components. The welding seam contour detection component 801 is used to detect the whole welding seam contours including the initial welding seam contour and the subsequent remaining welding seam contours of the welding seam 416. The welding seam contour calculation component 802 is used to calculate the detected welding seam contours. In one embodiment, the welding seam contour detection component 801 and the welding seam contour calculation component 802 are together used to perform the step 701 of the welding method 700 of FIG. 7. The welding trajectory point calculation component 803 is used to calculate welding trajectory points based on the calculated welding seam contours. In one embodiment, the welding trajectory point calculation component 803 is used to perform the steps 702, 707, and 709 of the welding method 700 of FIG. 7. The welding parameter setting component 804 is used to set welding parameters based on the calculated welding seam contours and the calculated welding trajectory points. In one embodiment, the welding parameter setting component 804 is used to perform the steps 703, 708, and 710 of the welding method 700 of FIG. 7. The welding control component 805 is used to perform welding process based on the set welding parameters. In one embodiment, the welding control component 805 is used to perform the steps 704 and 711 of the welding method 700 of FIG. 7.

Referring to FIG. 9, a schematic view of a detailed process performed by step 701 of the welding method 700 of FIG. 7 according to one embodiment is shown. More specifically, FIG. 9 shows an exemplary process to detect and calculate the initial welding seam contour 5011 of the welding seam 416 corresponding to the schematic 501 of FIG. 5.

In at least some embodiments, a teaching point 901 is set in every selected cross-sectional area of the welding seam 416. The number and position of the selected cross-sectional areas are determined according to the real shape of the welding seam 416, and will be discussed in following paragraphs. In FIG. 9, one selected cross-sectional area of the welding seam 416 is shown to explain how the shape of the cross-sectional area is calculated, and the shapes of other selected cross-sectional areas are calculated through similar methods.

The teaching point 901 is taught/set by manual operation through an operator operating the user interface 436 to drive the sensor 424. For the schematic cross-sectional area of the welding seam 116 shown in FIG. 9, the teaching point 901 can be approximately set in the center of the welding seam 416 by trial and error for example. In other embodiments, the position of the teaching point 901 can be adjusted according to different geometrical algorithms for calculating the initial welding seam contour 5011. The number of the teaching points 901 also can be changed according to different shapes of welding seams.

Based on the set teaching point 901, several searching paths are automatically generated. In one embodiment, five searching paths 9021, 9022, 9023, 9024, and 9025 are generated in every selected cross-sectional area of the welding seam 416 for example. The five searching paths 9021-9025 are generated according to the shape of the cross-sectional area of the welding seam 416. For example, two first searching paths 9021 and 9022 are generated from the teaching point 901 and respectively towards the opposite sides 4161 and 4162 of the welding seam 416, two second searching paths 9023 and 9024 are generated from a first starting point 902 and respectively towards the opposite sides 4161 and 4162 of the welding seam 416, and a third searching path 9025 is generated from the teaching point 901 and towards a gap 4163 of the welding seam 416. The first starting point 902 is automatically generated based on the teaching point 901 and is not located on the first searching paths 9021 and 9022. For example, the first starting point 902 is automatically located by the system at a predetermined distance D from the teaching point 901. In other embodiments, the number of the searching paths also can be amended according to different geometrical algorithms.

The generated searching paths 9021-9025 are sensed by the sensor 424. For example, the sensor 424 senses the opposite sides 4161 and 4162 of the welding seam 416 along the first searching path 9021 and the second searching path 9022, respectively. When the sensor 424 senses the side 4161 of the welding seam 416 during the detection process, a sensed point 9041 on the side 4161 is determined. Similarly, four other sensed points 9042, 9043, 9044, and 9045 on the welding seam 416 are determined by the sensor 424 during their individual detection process. With the five sensed points 9041-9045, the shape of the detected cross-sectional area of the welding seam 416 can be determined using, for example, two-dimensional geometry calculations. In other embodiments, the directions of the sensing paths 9021-9025 can be adjusted according to different geometrical algorithms, as long as the shape of the detected cross-sectional area of the welding seam 416 can be determined by the sensed points.

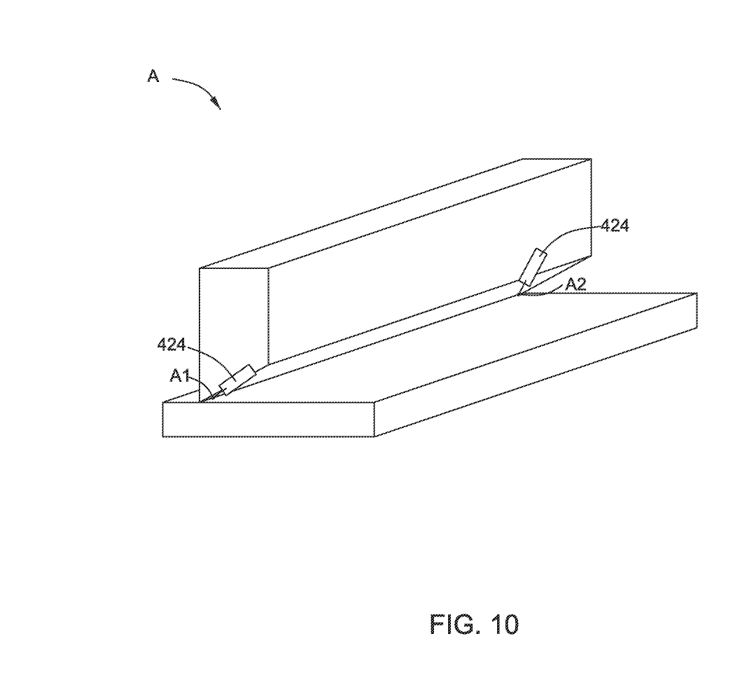

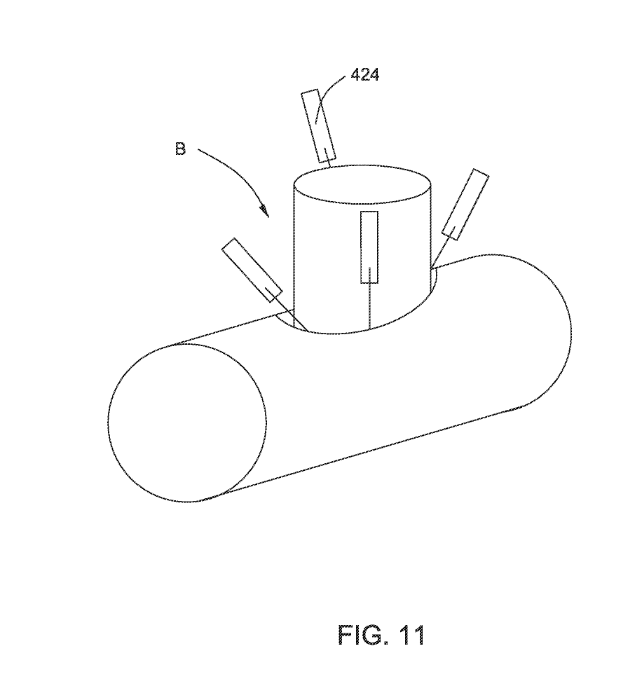

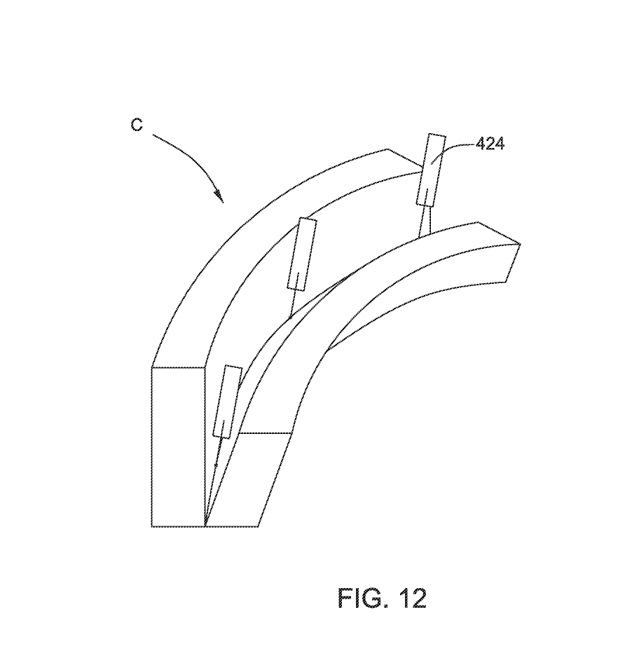

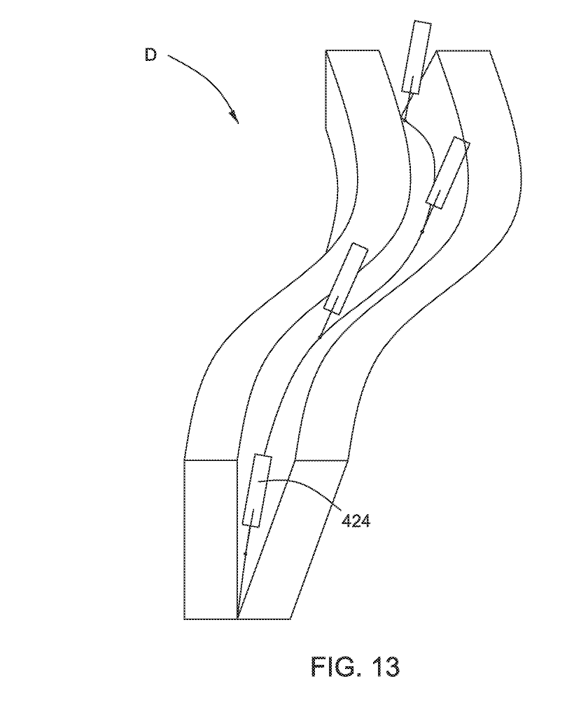

As the sensed points 9041-9045 are determined, the sensed points 9041-9045 are recorded. FIG. 9 only shows a cross-sectional area of the welding seam 416, however, to calculate the three-dimensional initial seam contour of the welding seam 416, several cross-sectional areas need to be sensed in a similar manner, and all sensed points on the several cross-sectional areas are recorded. For example, in FIG. 10, a straight welding seam A may need to be sensed at least two cross-sectional areas A1 and A2 at each end of the welding seam A. In FIG. 11, a ring-shaped welding seam B may need to be sensed at least four cross-sectional areas (not labeled) at four key positions of the welding seam B. In FIG. 12, an arc-shaped welding seam C may need to be sensed at least three cross-sectional areas (not labeled) at three key positions of the welding seam C. In FIG. 13, a general curve-shaped welding seam D is shown to show where and how many of the key cross-sectional areas are determined according to three-dimensional geometry. Therefore, any shapes of welding seams can be determined according to this general method shown in FIG. 13, wherein the key cross-sectional areas are determined according to three-dimensional geometry. Based on the recorded sensed points of all detected cross-sectional areas of the welding seam 416, the three-dimensional initial welding seam contour 5011 is calculated based on the recorded sensed points according to geometrical algorithms.

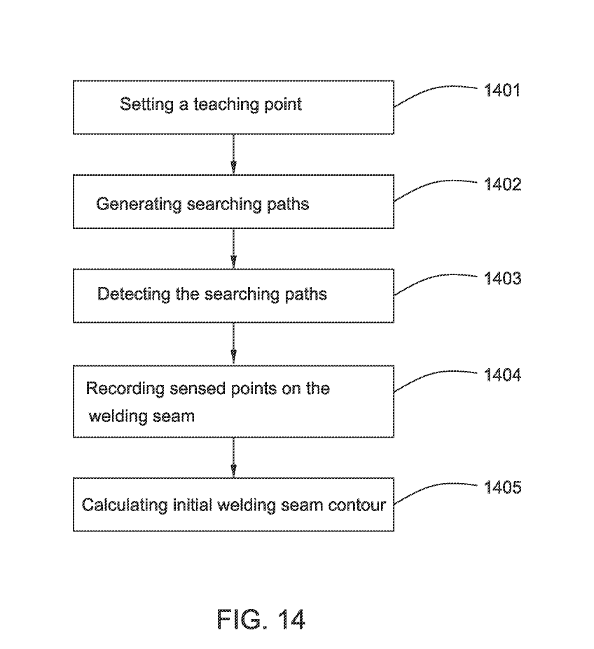

Referring to FIG. 14, a flowchart of a method corresponding to the detailed process of FIG. 9 according to one embodiment is shown. In step 1401, a teaching point 901 is set in every selected cross-sectional area of the welding seam 416. In step 1402, several searching paths (for example 9021-9025) are generated based on the set teaching point 901. In step 1403, the sensor 424 senses along the generated searching paths (for example 9021-9025) to detect the sides 4162, 4164 of the welding seam 416. In step 1404, all of the sensed points (for example 9041-9045) on the welding seam 416 are recorded. In step 1405, the initial welding seam contour 5011 is calculated based on the recorded sensed points.

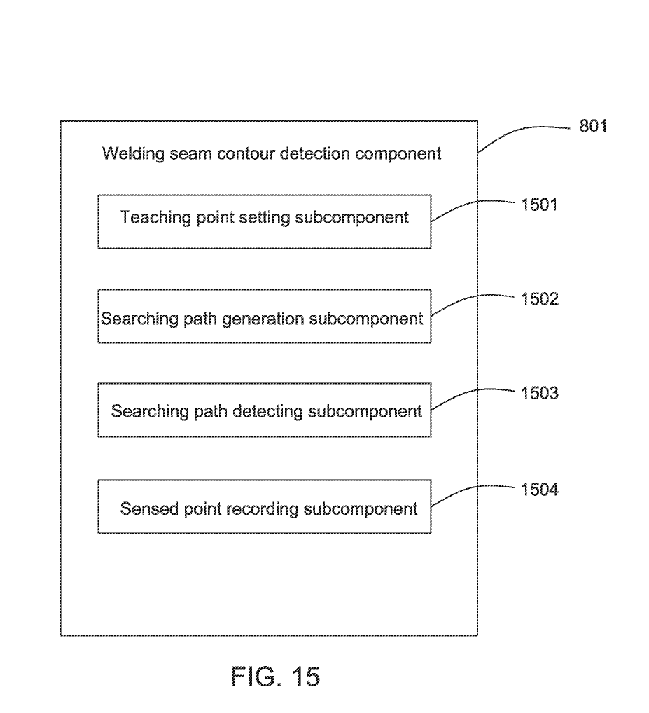

Referring to FIG. 15, a partial block diagram of a welding seam contour detection component 801 of the controller 434 of FIG. 8 is shown according to one embodiment. The welding seam contour detection component 801 includes a teaching point setting subcomponent 1501, a searching path generation subcomponent 1502, a searching path detecting subcomponent 1503, and a sensed point recording subcomponent 1504. The teaching point setting subcomponent 1501 is used to set a teaching point 901 in every selected cross-sectional area of the welding seam 416. In other words, the teaching point setting subcomponent 1501 is used to perform the step 1401 of the method of FIG. 14. The searching path generation subcomponent 1502 is used to generate several searching paths based on the set teaching point 901. In other words, the searching path generation subcomponent 1502 is used to perform the step 1402 of the method of FIG. 14. The searching path detecting subcomponent 1503 is used to detect the generated several searching paths. In other words, the searching path detecting subcomponent 1503 is used to perform the step 1403 of the method of FIG. 14. The sensed point recording subcomponent 1504 is used to record all of the sensed points on the welding seam 416. In other words, the sensed point recording subcomponent 1504 is used to perform the step 1404 of the method of FIG. 14. The welding seam contour calculation component 802 is used to perform the step 1405 of the method of FIG. 14.

Referring to FIG. 16, a schematic view of a detailed process performed by the step 705 of the welding method of FIG. 7 according to one embodiment is shown. More specifically, FIG. 16 shows a detail process to detect and calculate the remaining welding seam contour (for example 5041, 5071) of the welding seam 416 corresponding to the schematic 504, 507 of FIG. 5.

In at least some embodiments, a height/thickness of a welded area (e.g., weld bead deposited area) 1602 is determined. The sensor 424 is controlled to sense the third searching path 9025 again. When the sensor 424 senses the top of the welded area 1602, a sensed point 9046 on the top of the welded area 1602 is determined, and then the height (from the sensed point 9045 to the sensed point 9046) of the welded area 1602 is determined. After the height of the welded area 1602 is determined, a rough remaining welding seam contour 1603 is determined based on the calculated initial welding seam contour 5011 and the determined height of the welded area 1602 according to geometrical algorithms.

A width of the next layer for welding is then determined. In one embodiment, a second starting point 903 is calculated upon the sensed point 9046 along the searching path 9025, and the distance d between the second starting point 903 and the sensed point 9046 is equal to a predetermined height of the next layer. Two fourth searching paths 9026 and 9027 are generated from the starting point 903 and respectively towards the opposite sides 4161 and 4162 of the welding seam 416.

The sensor 424 is controlled to sense the opposite sides 4161 and 4162 of the welding seam 416 along the searching path 9026 and the searching path 9027 respectively. When the sensor 424 senses the side 4161 of the welding seam 416 during the detection process, a sensed point 9047 on the side 4161 is determined. Similarly, when the sensor 424 senses the side 4162 of the welding seam 416 during the detection process, a sensed point 9048 on the side 4162 is determined. The distance ‘w’ between the sensed point 9047 and the sensed point 9048 is equal to the width of the next layer; therefore the width ‘w’ of the next layer is determined accordingly. In other embodiments, the width ‘w’ of the next layer also can be determined according to other geometrical algorithms.

Based on the calculated initial welding seam contour 5011 and the determined height of the welded area 1602 and the width ‘w’ of the next layer, the remaining welding seam contour 1603 is calculated according to geometrical algorithms. Here, the information of the remaining welding seam contour 1603 includes the shape thereof and the width ‘w’ of the next layer as well. In other embodiments, calculating the width ‘w’ of the next layer may be omitted. For example, when the top of the welded area 1602 is quite flat and the shape of the welding seam 416 is regular, the width of the next layer can be determined just by estimation algorithms without determining the sensed points 9047 and 9048. However, the data of the calculated width ‘w’ of the next layer can make the process for setting welding parameters of the next layer more accurate.

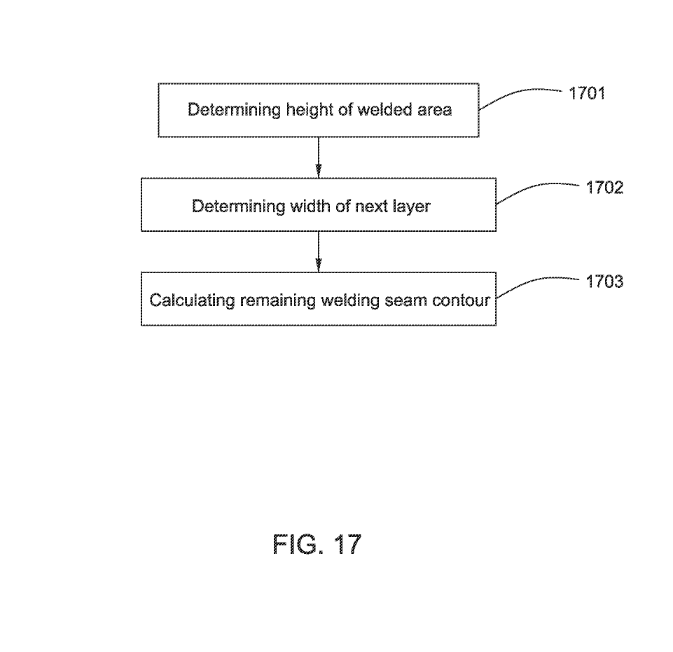

Referring to FIG. 17, a flowchart of a method corresponding to the detailed process of FIG. 16 according to one embodiment is shown. In step 1701, a height of the welded area 1602 is determined. In step 1702, a width w of the next layer of welding is determined. In step 1703, the remaining welding seam contour 1603 is calculated based on the calculated height of the welded area 1602 and the width w of the next layer.

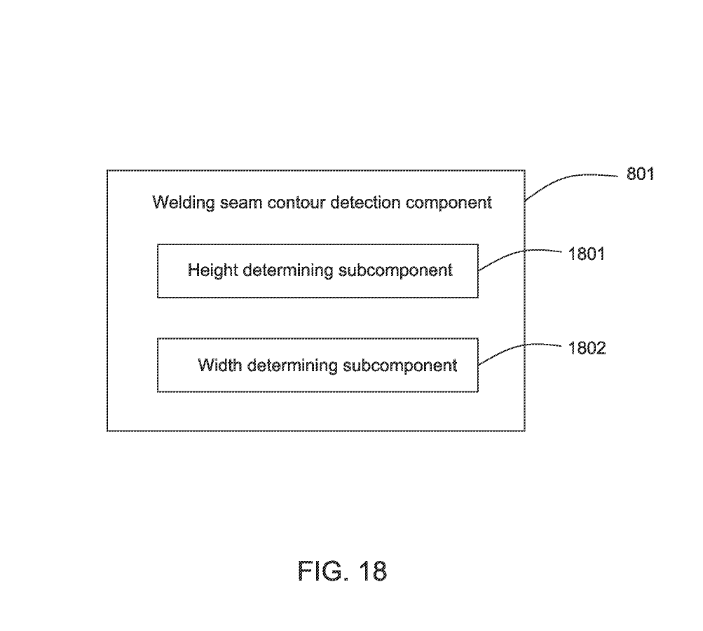

Referring to FIG. 18, another partial block diagram of a welding seam contour detection component of the controller of FIG. 8 according to one embodiment is shown. The welding seam contour detection component 801 further includes a height determining subcomponent 1801 and a width determining subcomponent 1802. The height determining subcomponent 1801 is used to calculate the height of the welded area 1602. In other words, the height determining subcomponent 1801 is used to perform the step 1701 of the method of FIG. 17. The width determining subcomponent 1802 is used to calculate the width w of the next layer of welding. In other words, the width determining subcomponent 1802 is used to perform the step 1702 of the method of FIG. 17. The welding seam contour calculation component 802 is used to perform the step 1703 of the method of FIG. 17.

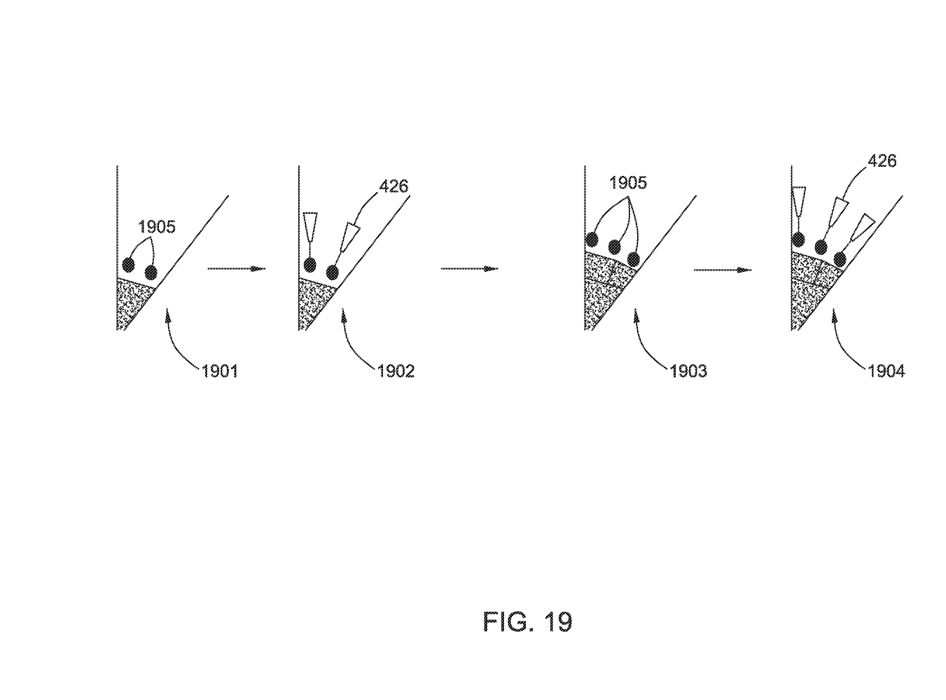

Referring to FIG. 19, a schematic view of a detailed process performed by the steps 702, 707, and 709 of the welding method of FIG. 7 according to one embodiment is shown. In other words, FIG. 19 shows a detail process to calculate welding trajectory points (for example 5021, 5051, 5072) of the welding seam 416 corresponding to the schematic 502, 505, 507 of FIG. 5.

The number of welding passes of a corresponding layer is determined based on the calculated remaining welding seam contours corresponding to the schematic 1901 and 1903 of FIG. 19. In some embodiments, because the width of every next layer is determined (see step 1702 in FIG. 17), the calculated number of the welding passes is more accurate. For example, the schematic 1901 shows two welding passes on the second layer, and the schematic 1903 shows three welding passes on the third layer.

Based on the calculated number of welding passes and the calculated welding seam contours, the welding position of each welding trajectory point 1905 is exactly determined according to applied welding technology. The schematics 1901 and 1903 show exemplary welding positions.

Based on the determined position of each welding trajectory point 1905 of every layer and the calculated welding seam contours for every layer welding mentioned above, the welding gesture of each welding trajectory point 1905 (namely the welding gesture of the welding torch 426 on every welding trajectory point 1905) is exactly determined according to applied welding technology corresponding to the schematic 1902 and 1904 of FIG. 19. In one embodiment, the reference data for determining the number of welding passes and the position and gesture of the welding points are stored in a database in advance based on previous experiential results. In other embodiments, operators also can amend some parameters through the user interface 436 if desired.

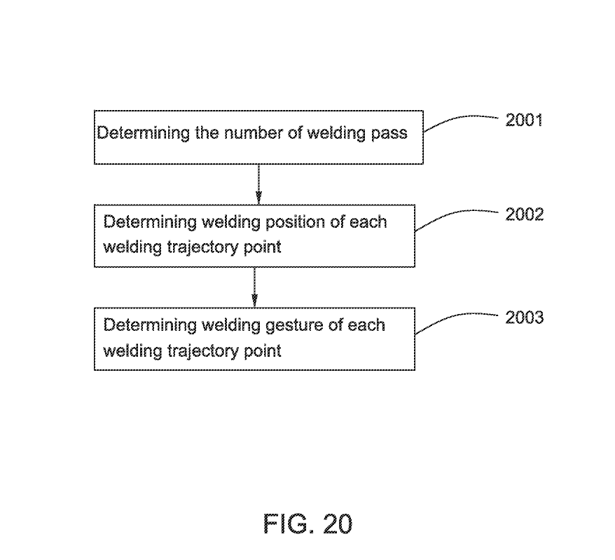

Referring to FIG. 20, a flowchart of a method corresponding to the detailed process of FIG. 19 according to one embodiment is shown. In step 2001, the number of the welding passes is determined. In step 2002, the welding position of each welding trajectory point 1905 is determined. In step 2003, the welding gesture of each welding trajectory point 1905 is determined

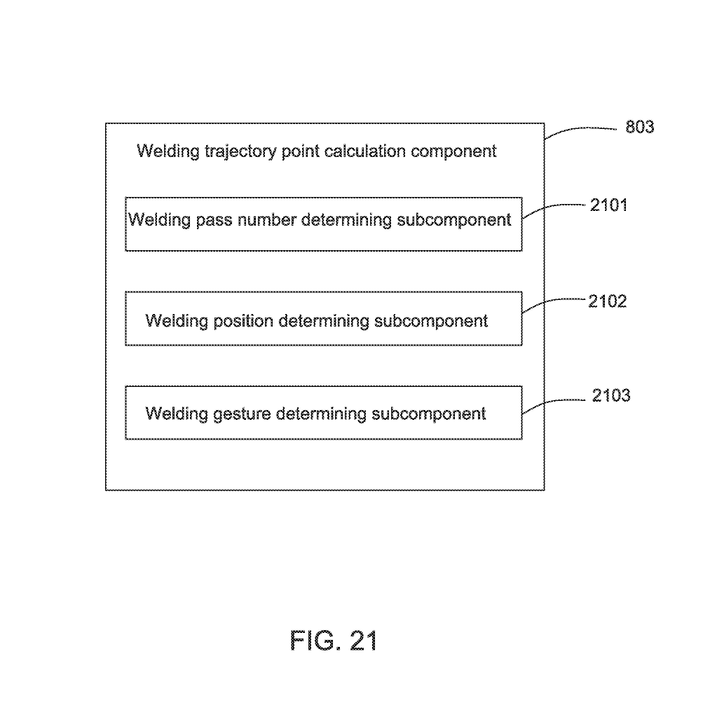

Referring to FIG. 21, a block diagram of the welding trajectory point calculation component 803 of the controller 434 of FIG. 8 according to one embodiment is shown. The welding trajectory point calculation component 803 includes a welding pass number determining subcomponent 2101, a welding position determining subcomponent 2102, and a welding gesture determining subcomponent 2103. The welding pass number determining subcomponent 2101 is used to calculate the pass number of every welding layer. In other words, the welding pass number determining subcomponent 2101 is used to perform the step 2001 of the method of FIG. 20. The welding position determining subcomponent 2102 is used to calculate the welding position for each welding trajectory point 1905. In other words, the welding position determining subcomponent 2102 is used to perform the step 2002 of the method of FIG. 20. The welding gesture determining subcomponent 2103 is used to calculate the welding gesture for each welding trajectory point 1905. In other words, the welding gesture determining subcomponent 2103 is used to perform the step 2003 of the method of FIG. 20. In some embodiments, the welding position determining subcomponent 2102 may be omitted, for example when the welding gestures of all welding trajectory points are the same.

Because the automatic welding system 400 only needs to have a minimal set of teaching points 901 manually set in order to automatically calculate all of the welding seam contours (for example, only two teaching points for a straight welding seam), and perhaps thousands of welding trajectory points and corresponding welding parameters based on each of the calculated welding seam contours, welding efficiency can be significantly increased. Furthermore, in accordance with one embodiment, the controller 434 can automatically recalculate the remaining welding seam contours (including the width of the next layer in some embodiments) and recalculate subsequent welding trajectory points of filling and surface welding after every layer is welded. Accordingly, the automatic welding system 400 can accurately deal with welding processes in every layer, which means the system 400 is adaptable to perform complex welding operations in different conditions, such as for welding super-thick welding seams, for multi-pass/multi-layer welding, for flat welding, for uphill welding, for horizontal welding, for fillet welding, for example.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

1. A welding system for automatically welding a welding seam, the system comprising:
a welding arm;
a sensor coupled to the welding arm to sense contours of the welding seam; and
a controller coupled to the sensor and the welding arm controlling the welding process based on the sensed contours, the controller comprising:
a welding seam contour detection component detecting an initial welding seam contour and detecting remaining welding seam contours after welding each layer of the welding seam;
a welding seam contour calculation component calculating the detected welding seam contours;
a welding trajectory point calculation component calculating welding trajectory points based on the calculated welding seam contours; and
a welding parameter setting component setting welding parameters based on the calculated welding seam contours and the calculated welding trajectory points, wherein the welding trajectory point calculation component comprises:
a welding pass number determining subcomponent determining number of welding passes of each layer based on the calculated welding seam contours;
a welding position determining subcomponent determining welding position of the welding trajectory points based on the determined number of welding passes of each layer and the calculated welding seam contours; and
a welding gesture determining subcomponent determining welding gesture of welding trajectory points based on the determined welding position of the welding trajectory points of each layer and the calculated welding seam contours.

2. The welding system of claim 1, wherein the welding seam contour detection component comprises:
a teaching point setting subcomponent for setting a teaching point on each of selected cross-sectional areas of the welding seam;
a searching path generation subcomponent for generating a plurality of searching paths based on the set teaching point of each selected cross-sectional area of the welding seam;
a searching path detecting subcomponent for detecting the calculated searching paths by the sensor respectively; and
a sensed point recording subcomponent for recording sensed points by the sensor on the sides of the welding seam.

3. The welding system of claim 2, wherein the selected cross-sectional areas comprise two cross-sectional areas when the welding seam is a straight welding seam, or four cross-sectional areas when the welding seam is a ring-shaped welding seam, or at least three cross-sectional areas when the welding seam is an arc-shaped welding seam.

4. The welding system of claim 2, wherein the teaching point is set by manual operation.

5. The welding system of claim 2, wherein the welding seam contour detection component further comprises a height determining subcomponent for determining a height of a welded area of the welding seam.

6. The welding system of claim 5, wherein the welding seam contour detection component further comprises a width determining subcomponent for determining a width of a next layer to be welded.

7. The welding system of claim 2, wherein the plurality of searching paths of each selected cross-sectional area of the welding seam comprises two first searching paths, two second searching paths, and a third searching path, the two first searching paths are calculated from the teaching point and respectively towards the opposite sides of the welding seam, the two second searching paths are calculated from a first starting point and respectively towards the opposite sides of the welding seam, and the third searching path is calculated from the teaching point and towards a gap of the welding seam; wherein the first starting point is calculated based on the teaching point and is not located on the first searching paths.

8. The welding system of claim 7, wherein the welding seam contour detection component further comprises a height determining subcomponent for determining a height of a welded area of the welding seam; wherein the height determining subcomponent controls the sensor to sense the third searching path, to determine the height of the welded area.

9. The welding system of claim 8, wherein the welding seam contour detection component further comprises a width determining subcomponent for determining a width of a next layer to be welded; wherein the width determining subcomponent controls the sensor to sense two fourth paths calculated from a second starting point and respectively towards the opposite sides of the welding seam, to determine the width of a next layer; wherein the second starting point is calculated based on the detected welded area and a predetermined height of the next layer.

10. (canceled)

11. A non-transitory computer readable media embodying instructions, which when executed by a processor cause the computer to perform an automatic welding method, the welding method comprising:
detecting and calculating an initial welding seam contour of the welding seam;
calculating welding trajectory points of a root welding based on the calculated initial welding seam contour;
setting welding parameters of the root welding based on the calculated welding trajectory points and the calculated initial welding seam contour;
performing one layer welding based on the set welding parameters;
detecting and calculating a remaining welding seam contour of the welding seam; and
determining whether the calculated remaining welding seam contour is for a surface welding; wherein
when the calculated remaining welding seam contour is not for the surface welding,
calculating welding trajectory points of filling welding based on the calculated remaining welding seam contour, setting welding parameters of filling welding based on the calculated welding trajectory points and the calculated remaining welding seam contour, and performing one layer welding based on the set welding parameters, and
when the calculated remaining welding seam contour is for the surface welding,
calculating welding trajectory points of surface welding based on the calculated remaining welding seam contour, setting welding parameters of surface welding based on the calculated welding trajectory points and the calculated remaining welding seam contour, and performing surface welding based on the set welding parameters.

12. The non-transitory computer readable media of claim 11, wherein detecting an initial welding seam contour of the welding seam comprises:
setting a teaching point on each of selected cross-sectional areas of the welding seam;
generating a plurality of searching paths based on the set teaching point of each selected cross-sectional area of the welding seam;
detecting the calculated searching paths by a sensor respectively; and
recording sensed points by the sensor on the sides of the welding seam.

13. The non-transitory computer readable media of claim 12, wherein setting a teaching point on each of selected cross-sectional areas of the welding seam comprises setting two teaching points on two cross-sectional areas respectively when the welding seam is a straight welding seam, or setting four teaching points on four cross-sectional areas respectively when the welding seam is a ring-shaped welding seam, or setting three teaching points on three cross-sectional areas respectively when the welding seam is an arc-shaped welding seam.

14. The non-transitory computer readable media of claim 12, wherein detecting a remaining welding seam contour of the welding seam further comprises:
determining a height of a welded area of the welding seam.

15. The non-transitory computer readable media of claim 14, wherein detecting a remaining welding seam contour of the welding seam further comprises:
determining a width of a next layer to be welded.

16. The non-transitory computer readable media of claim 12, wherein generating a plurality of searching paths based on the set teaching point of each selected cross-sectional area of the welding seam comprises:
generating two first searching paths from the teaching point and respectively towards the opposite sides of the welding seam;
generating two second searching paths from a first starting point and respectively towards the opposite sides of the welding seam; and
generating a third searching path from the teaching point and towards a gap of the welding seam;
wherein the first starting point is calculated based on the teaching point and is not located on the first searching paths.

17. The non-transitory computer readable media of claim 16, wherein detecting a remaining welding seam contour of the welding seam further comprises:
sensing the third searching path by the sensor again; and
determining a height of a welded area of the welding seam.

18. The non-transitory computer readable media of claim 17, wherein detecting a remaining welding seam contour of the welding seam further comprises:
generating two fourth searching paths from a second starting point and respectively towards the opposite sides of the welding seam;
detecting the calculated fourth searching paths by the sensor; and
determining a width of a next layer to be welded;
wherein the second starting point is calculated based on the detected welded area and a predetermined height of the next layer.

19. The non-transitory computer readable media of claim 11, wherein generating welding trajectory points comprises:
determining number of welding passes of each layer based on the calculated welding seam contours; and
determining welding position of the welding trajectory points based on the determined number of welding passes of each layer and the calculated welding seam contours.

20. The non-transitory computer readable media welding of claim 19, wherein generating welding trajectory points further comprises:
determining welding gesture of welding trajectory points based on the determined welding position of the welding trajectory points of each layer and the calculated welding seam contours.
